(19) United States
(12) Patent Application Publication
(10) Pub. No.: US 2025/0090416 A1
(43) Pub. Date: Mar. 20, 2025

(54) IMMERSIVE STIMULATION SYSTEM WITH VIBRATION DEVICE AND AUDIO SYNCHRONIZATION

(71) Applicant: Michael Weiss-Malik, Pacifica, CA (US)

(72) Inventor: Michael Weiss-Malik, Pacifica, CA (US)

(21) Appl. No.: 18/796,275

(22) Filed: Aug. 6, 2024

Related U.S. Application Data
(60) Provisional application No. 63/538,759, filed on Sep. 15, 2023.

(51) Int. Cl. A61H 23/02; A61H 19/00

(52) U.S. Cl. CPC A61H 23/0236; A61H 19/44; A61H 2201/0107; A61H 2201/0153; A61H 2201/1207; A61H 2201/16; A61H 2201/5005; A61H 2201/5015; A61H 2201/5046; A61H 2201/5048; A61H 2201/5082; A61H 2201/5097; A61H 2205/087

(57) ABSTRACT

An immersive stimulation system generates audio (such as music) and a vibration signal that causes a stimulation device to vibrate synchronously with the audio. The vibrations may be synchronized with respect to amplitude and frequency such that frequency components of the vibrations adapt in coordination with time-dependent frequency distributions of the audio. The immersive stimulation system may include a control device for generating the audio and vibration signals and a stimulation device that produces the vibrations based on the vibration signal. The stimulation device may include one or more voice coil transducers to produce the vibrations and a detachable vibratory unit that may have different form factors depending on the desired usage of the stimulation system.

### CROSS-REFERENCE TO RELATED APPLICATIONS

This application claims the benefit of U.S. Provisional Patent Application No. 63/538,759 filed on Sep. 15, 2023, which is incorporated by reference herein.

### BACKGROUND

### Technical Field

This application relates generally to a vibrating stimulation system and more specifically, to a vibration device that synchronizes vibrations to audio.

### Description of Related Art

Conventional personal vibrating devices such as personal massagers, sexual stimulation devices, or other similar devices typically include one or more vibrational motors powered by a battery or other power supply. Some more advanced devices may include various programmatic capabilities that enable user control over vibration intensity and/or on/off patterns. However, conventional devices are relatively simple and lack the capability of providing immersive multi-sensory experiences.

### BRIEF DESCRIPTION OF THE DRAWINGS

FIG. 1 is an example embodiment of a stimulation system that generates audio and causes vibrations of a stimulation device synchronized to the audio.

FIG. 2 is a block diagram illustrating example electronics for a control device of a stimulation system.

FIG. 3 is a first example of signal processing paths associated with generating output audio and a synchronized vibration signal in a stimulation system.

FIG. 4 is a second example of signal processing paths associated with generating output audio and a synchronized vibration signal in a stimulation system.

FIG. 5 is a flowchart illustrating an example method for operating a stimulation system.

FIG. 6 is an example product design for a stimulation system.

FIG. 7 illustrates an example form factor for a vibratory unit of a stimulation device usable with the stimulation system.

FIG. 8 is an example of an internal structure of a transducer of a stimulation device.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made to several embodiments, examples of which are illustrated in the accompanying figures. It is noted that wherever practicable similar or like reference numbers may be used in the figures and may indicate similar or like functionality.

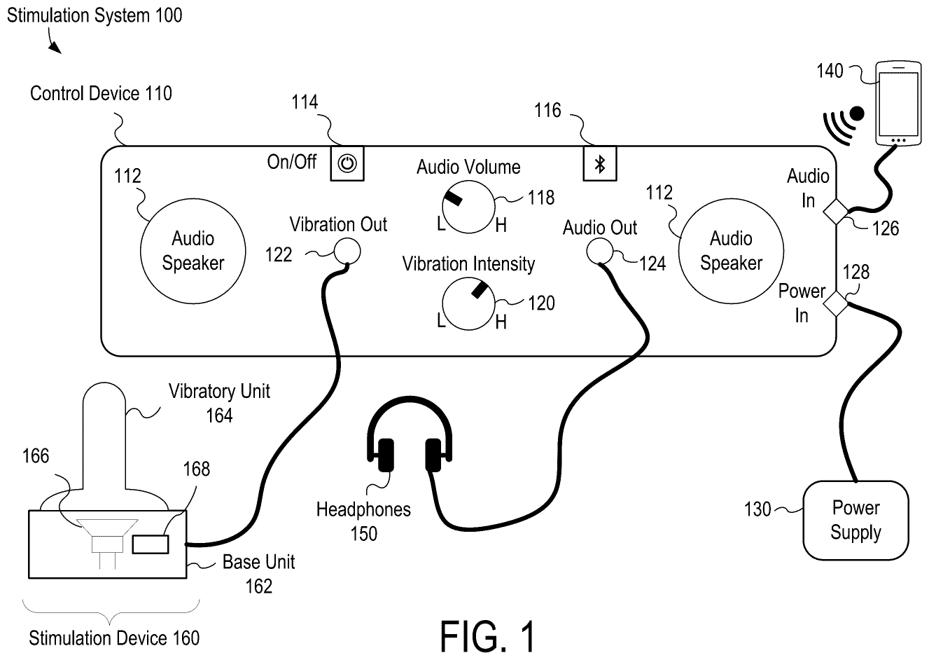

FIG. 1 is an example of an immersive stimulation system 100. The immersive stimulation system includes a control device 110 that generates audio (such as music) and a synchronized vibration signal that controls vibrations of a communicatively coupled stimulation device 160. The stimulation device 160 is generally structured to physically contact and transfer vibrations to one or more body parts. In some implementations, the stimulation device 160 may have a handheld form factor suitable for sexual stimulation and/or personal massage of one or more body parts. For example, the stimulation device 160 may have a form factor of a dildo, masturbation sleeve, or other form factor typical of personal vibrator devices designed for sexual stimulation. In other embodiments, the stimulation device 160 may comprise a form factor of a handheld massager that may be suitable for massaging the back, neck, legs, arms, feet, hands, or other anatomical features. In yet further embodiments, the stimulation device 160 may have a form factor that is not necessarily handheld, such as a seat, saddle, or other form factor suitable for stimulating the human anatomy via vibrations.

The control device 110 may generate the vibration signals such that the vibrations are time-synchronized in amplitude and/or frequency with changes in amplitude and/or frequency of the audio. Here, the relative amplitudes of frequency components of the vibration signal may track or otherwise be derived from the relative amplitudes of frequency components of the audio signal. For example, as a dominant frequency of the audio dynamically increases in frequency, the dominant frequency of the vibration signal may similarly increase and vice versa. The vibrations may also be synchronized to the audio with respect to amplitude such that overall increases in audio volume result in increased overall vibration intensity and vice versa. Moreover, at the frequency component level, increased amplitude of a particular frequency component of the audio signal may be mirrored in the vibration signal. Other more complex synchronization techniques may be employed to create a wide variety of immersive effects. For example, in other examples, the vibration signal may be derived using any combination of low-pass filters, high-pass filters, bandpass filters, or more complex equalization filters applied to the audio signal. Such filters may be time dependent and may dynamically change during playback of the audio. Furthermore, the vibration signal may be derived based in part on a time-dependent and/or frequency-dependent gain applied to the audio signal. Signal processing techniques such as phase-shifting, frequency shifting, and/or signal synthesis techniques may also be employed to derive the vibration signal from the audio signal.

The synchronization between the audio and the vibrations causes the user to experience a connection between the audio and the vibrations that results in an immersive multi-sensory experience. This experience can yield a significantly heightened sense of stimulation relative to uncoupled audio and/or vibrations. Moreover, the sensory experience may be configurable dependent on the type of synchronization employed to create different stimulation effects for the user.

The control device 110 may have a form factor suitable for placing on a tabletop (e.g., a nightstand) and may connect via a cable or wirelessly to the stimulation device 160. For example, the control device 110 may comprise a housing (e.g., plastic, metal, wood, or a combination thereof) with internal electronics that enable the functions of the control device 110 described herein. The control device 110 may have various input and output ports, controls, and/or indicators, which may enable user interactions and/or interactions with one or more external devices. In an example implementation, the control device 110 may include an audio input port 126, a power input port 128, one or more audio speakers 112, an audio output port 124, one or more indicators 116, and one or more control switches (e.g., on/off switch 114), an audio volume controller 118, and a vibration intensity controller 120.

The power input port 128 may couple to a power supply 130 such as a conventional electrical outlet that directly powers the control device 110 and/or charges an (optional) internal battery of the control device 110.

The audio input port 126 may couple to an audio source 140 via a wired connection (e.g., a Universal Serial Bus (USB) connection, an audio jack connection, or other interface) and/or a wireless connection (e.g., Bluetooth, WiFi, etc.). The audio source 140 may comprise any computing device such as a mobile phone, tablet, laptop computer, game console, or other device capable of streaming or downloading audio to the control device 110. In alternative embodiments, the control device 110 may be internet-enabled and couple directly with a remote audio server via one or more networks (which may include a local area network (LAN) and/or the Internet). In such embodiments, a physical audio input port 126 may be optionally omitted.

The audio speakers 112 output audio based on an audio signal received via the audio input port 126. The illustrated embodiment shows a pair of integrated audio speakers 112 that enable stereo audio output. In other implementations, the control device 110 may have only a single speaker or more than two integrated speakers 112.

The control device 110 may furthermore include an audio output port 124 that enables output of the audio signal to one or more external speakers such as headphones 150 or other types of speakers (e.g., floor-mounted speakers, table-mounted speakers, wall-mounted speakers, ceiling-mounted speakers, etc.). The audio output port 124 may comprise a wired and/or wireless connection. In some embodiments, the internal speakers 112 or the audio output port 124 may be omitted.

The audio volume controller 118 enables user control of the overall output audio volume. The audio volume controller 118 may comprise a physical dial, one or more buttons, a touch screen interface, or other physical control accessible to a user. The audio volume controller 118 may furthermore comprise a control interface that does not necessarily include a physical control element, such as a remote control receiver (e.g., a dedicated remote and/or paired mobile application), a voice recognition controller, a gesture recognition controller, or other control mechanism. External control elements may be coupled wirelessly and/or via a wired connection.

The vibration output port 122 outputs a vibration signal (derived directly or indirectly from the audio input signal) to the stimulation device 160. The vibration output port 122 may comprise a wired and/or wireless connection to the stimulation device 160.

The vibration intensity controller 120 enables user control of the output vibration intensity. The vibration intensity controller 120 may comprise a physical dial, one or more buttons, a touch screen interface, or other physical control accessible to a user. The vibration intensity controller 120 may furthermore comprise a control interface that does not necessarily include a physical control element, such as a remote control receiver (e.g., a dedicated remote and/or paired mobile application), a voice recognition controller, a gesture recognition controller, or other control mechanism. External control elements may be coupled wirelessly and/or via a wired connection. In an embodiment, the vibration intensity may be controlled at least in part by an automated gain controller that may dynamically change gain in response to sensed temperature of the stimulation device 160 or other conditions. For example, intensity may be automatically reduced in some or all frequency ranges in response to increasing temperature.

The on/off switch 114 may comprise a physical control to turn the control device 110 on or off. The on/off switch may comprise a toggle button, switch, or other physical control. Alternatively, the control device 110 may be wirelessly activated and/or deactivated via a wireless signal from a remote controller, a voice control, gesture control, or other control mechanism. While FIG. 1 illustrates only an on/off switch 114 as one example of a control input, the control device 110 may include other types of control buttons, switches, or other control elements for controlling various configuration parameters of the control device 110.

The one or more indicators 116 may output one or more status parameters of the control device 110. For example, the one or more indicators 116 may indicate whether the control device 110 has an active wireless connection to an audio source 140 (e.g., via Bluetooth). Control indicators 116 may furthermore be included to indicate other status elements such as on/off status, battery status, connectivity status with respect to the stimulation device 160 and/or external headphones 150, or other status characteristics.

The stimulation device 160 may comprise a base unit 162 and a vibratory unit 164. The base unit 162 may comprise a housing with one or more integrated transducers 166 and an optional heat sensor 168 (e.g., thermistor).

The one or more transducers 166 receives the vibration signal from the control device 110 and generates vibrations, which resonate through the housing of the base unit 162 and the vibratory unit 164. In an embodiment, the transducer 166 comprises a voice coil transducer that generates a magnetic field in response to an electrical signal (i.e., the vibration signal generated from the control device 110) through a coil. The magnetic field produces a motive force in a magnet such that the magnet vibrates relative to the coil. These vibrations are transferred to the vibratory unit 164 via a mechanical coupling. In some embodiments, the base unit 162 may include two or more transducers 166 that may operate together.

The heat sensor 168 senses heat of the housing of the base unit 162 and sends a temperature or other sensing signal to the control device 110. In this embodiment, the connection between the base unit 162 and the control device 110 may comprise a four-wire connection in which two wires are used to communicate the vibration signal and two wires are used to communicate the temperature signal. Alternatively, a wireless communication interface or other type of wired link may be used.

In other alternative embodiments, the base unit 162 may include an active cooling element (e.g., an integrated exhaust fan) instead of or in addition to the heat sensor 168 described above. In this implementation, the control device 110 may send control signals to control the cooling element (e.g., turn the fan on or off) dependent on the sensed temperature.

In yet further embodiments, vibration gain control and/or cooling control may be implemented on the stimulation device 160 itself. Here, the stimulation device 160 does not necessarily send the sensed temperature to the control device 110 and instead may include an integrated controller that applies active gain adjustment and/or cooling control in response to the locally sensed temperature.

The stimulation device 160 may also optionally incorporate one or more passive cooling elements such as vents, etc.

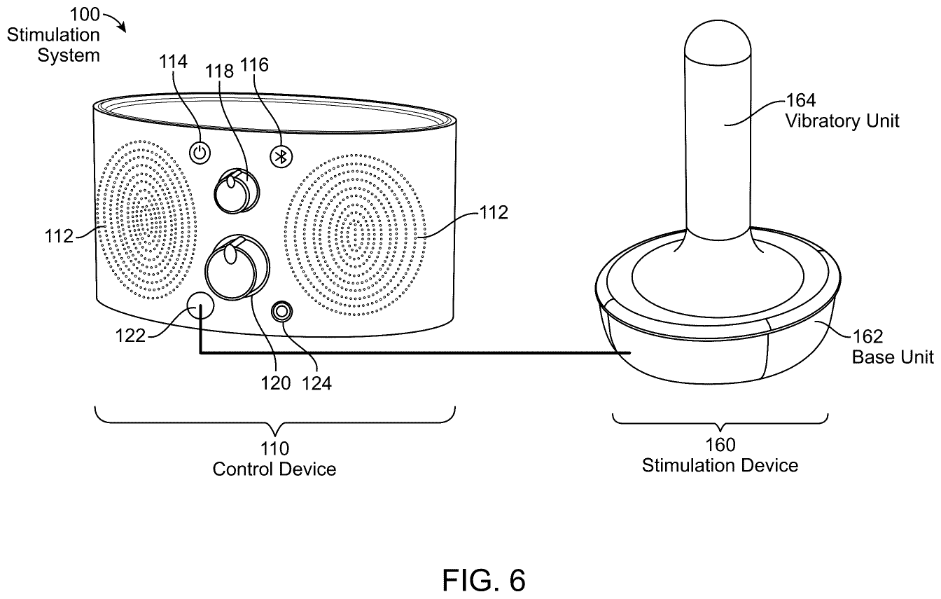

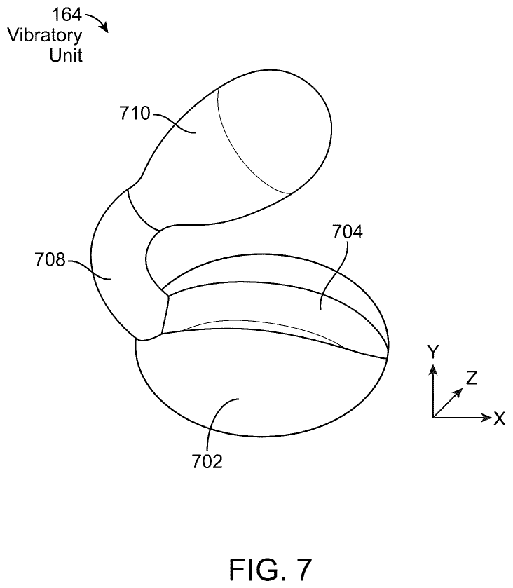

The vibratory unit 164 may comprise a passive device that does not itself include integrated electronics. The vibratory unit 164 may be composed of any suitable material such as hard or soft plastic, rubber, wood, metal, fabrics, composite materials, or a combination thereof. In an embodiment, the vibratory unit 164 is removeable from the base unit 162. In such embodiments, different vibratory units 164 having different form factors may be coupled and/or decoupled from the base unit 162. This enables users to attach different types of vibratory units depending on personal preferences and intended usage. For example, as described above, different form factors of the vibratory unit 164 may be desirable dependent on whether the stimulation system 100 is being used for massage or sexual stimulation, dependent on whether the stimulation system 100 is being applied to male or female anatomy, and dependent on the specific body part the user intends to stimulate. In other embodiments, the vibratory unit 164 and base unit 162 may comprise a unibody construction without a detachable vibratory unit 164. Example form factors for vibratory units 164 are described in further detail below with respect to FIGS. 6-7.

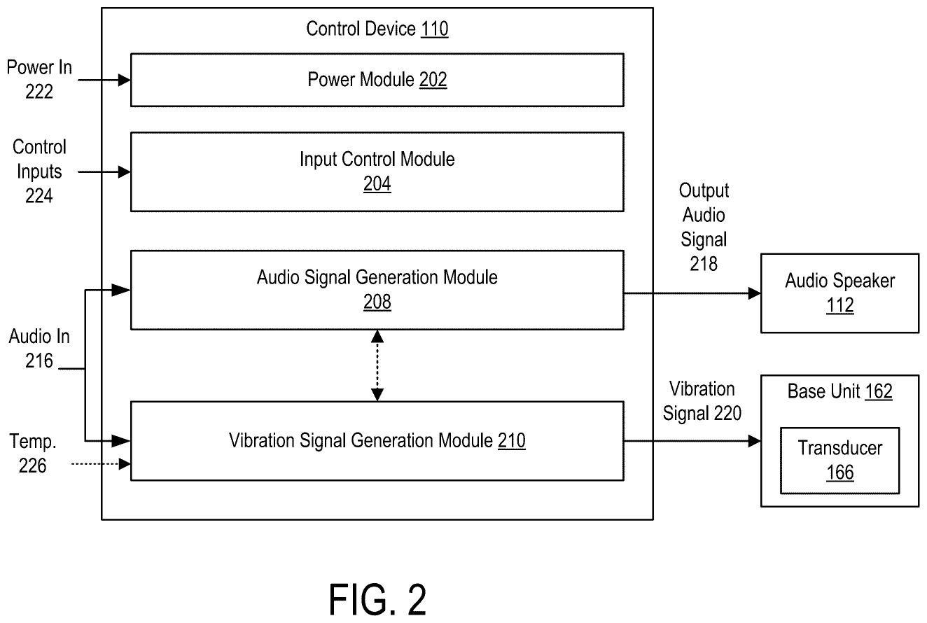

FIG. 2 is a block diagram illustrating an example embodiment of the internal electronics of the control device 110. The control device 110 may comprise a power module 202, an input control module 204, an audio signal generation module 208, and a vibration signal generation module 210. In alternative embodiments, the control device 110 may include additional or different electronic components.

The power module 202 controls power to various electronics of the control device 110. The power module 202 may optionally include an integrated battery and may include one or more power converters for supplying power to the electronics from the battery or external power source. If the control device 110 includes an integrated battery, the power module 202 may control charging of the battery and various battery monitoring functions. The power module 202 may furthermore include components such as regulators, power converters, safety mechanisms, or other power system components.

The input control module 204 receives one or more control inputs 224 and controls a configuration of the control device 110 based on the control inputs 224. The control inputs 224 may comprise, for example, a volume control input (e.g., received via an audio volume controller 118) that controls a gain of the output audio signal 218, a vibration intensity input (e.g., received via a vibration intensity controller 120) that controls a gain of the vibration output signal, an on/off control (e.g., received via an on/off switch 114), or other physical control on the control device 110. The control inputs 224 may furthermore comprise electronic control signals received from an external remote control (not shown) or a mobile device (which may also be the audio source 140) executing a linked mobile application that operates as a remote controller. The audio signal generation module 208 and vibration signal generation module 210 generate the output audio signal 218 and the vibration signal 220 respectfully based on an audio input signal 216. The audio signal generation module 208 and vibration signal generation module 210 may be configured to apply one or more filters (e.g., such as a high pass filter, low pass filter, bandpass filter, or more complex equalization filters that may apply a frequency-dependent gain), one or more amplifiers (which may be controllable in part via the control inputs 224), and/or one or more other signal processing functions such as frequency-shifting, phase-shifting, or other signal processing effects. The various signal shaping elements may be implemented using analog circuit components (e.g., resistors, capacitors, inductors, or other components suitable for analog filters or other signal shaping elements), digital circuit components (e.g., digital filters), one or more signal processors (comprising a processor that executes instructions loaded from one or more storage mediums), or a combination thereof.

In one implementation, the audio signal generation module 208 and vibration signal generation module 210 may comprise independent signal processing paths. Alternatively, at least some signal processing elements may be shared between the audio signal generation module 208 and the vibration signal generation module 210.

The audio signal generation module 208 and vibration signal generation module 210 may operate in a coordinated manner such that the output audio signal 218 and the vibration signal 220 are time-synchronized based on frequency, intensity, or a combination thereof. Thus, changes in the frequency spectrum and amplitude of the audio signal over time result in corresponding changes in the vibration signal 220 to create an immersive multi-sensory stimulation experience for the user. The audio and vibration signals may be coordinated in different ways by deriving the output audio signal 218 and vibration signal 220 as respective functions of the same audio input signal 216. These different synchronization techniques may create varying experiences for the user and may be customized dependent on the desired sensations.

In some embodiments, the vibration signal generation module 210 may furthermore dynamically control vibration intensity of the vibration signal 220 based on a temperature signal 226 from the stimulation device 160. For example, in one embodiment, vibration intensity may be automatically reduced to maintain the temperature below a desired set point. Here, the vibration signal generation module 210 may reduce the overall gain (independent of frequency) or may apply a frequency-dependent reduction such that only certain frequencies are attenuated, or different frequencies are attenuated by different amounts. In one such implementation, the vibration signal generation module 210 may furthermore incorporate some hysteresis into the control protocol such that the gain is not rapidly just adjusted when the temperature is at or near the set point. As described above, the temperature-based vibration intensity control may alternatively be implemented at least in part by a controller internal to the stimulation device 160 without necessarily sending temperature readings to the control device 110.

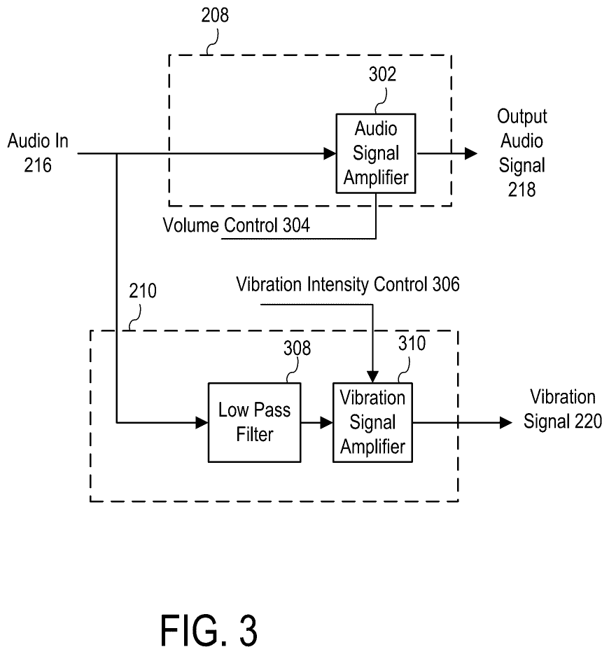

FIG. 3 illustrates one example of the signal processing paths of the audio signal generation module 208 and the vibration signal generation module 210. In this example, the audio signal generation module 208 receives the audio input signal 216 and directly inputs it to an audio signal amplifier 302 that amplifies the signal according to a gain controlled by a volume control 304 to generate the output audio signal 218. The vibration signal generation module 210 includes a low pass filter 308 that attenuates frequencies of the audio input signal 216 above a cutoff frequency, and a vibration signal amplifier 310 that amplifies the filtered signal based on the vibration intensity control 306 to generate the vibration signal 220. The low pass filter has the effect of attenuating high frequency vibrations which may produce undesirable audible noise from the transducer 166. In an alternative embodiment, the low pass filter 308 may instead be applied after the vibration signal amplifier 310.

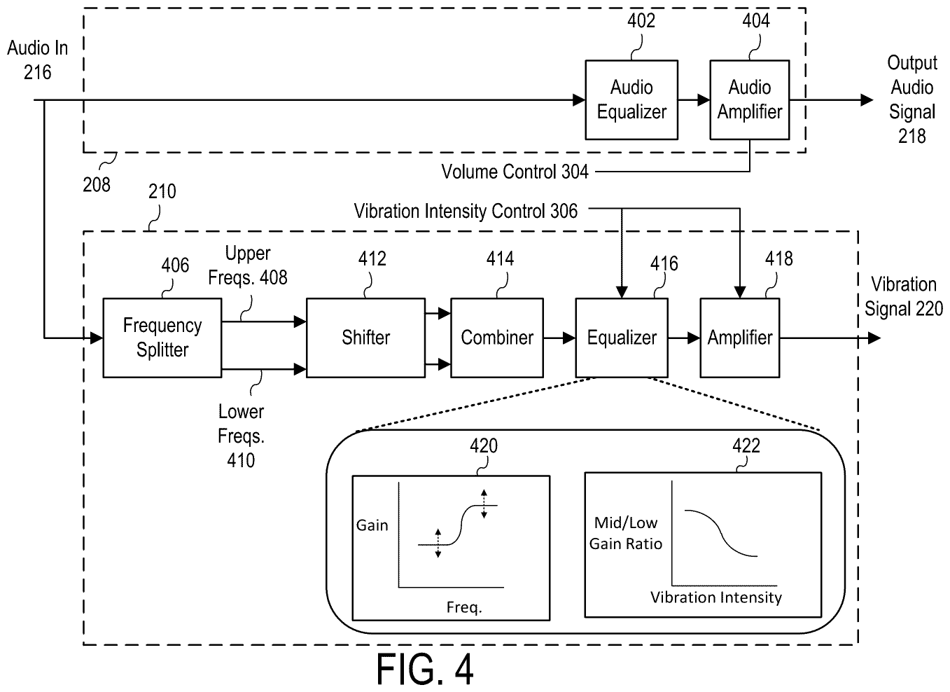

FIG. 4 is another example of signal processing paths associated with the audio signal generation module 208 and the vibration signal generation module 210. In this example, the audio signal generation module 208 obtains the audio input signal and passes it through an audio equalizer 402 and audio amplifier 404 to generate the output audio signal 218. The audio equalizer 402 may apply a frequency-dependent gain to achieve a desired equalization of the audio frequency spectrum. The audio amplifier 404 applies a gain controllable at least in part by the volume control 304. In alternative implementations, the audio amplifier 404 may be applied before the audio equalizer 402.

The vibration signal generation module 210 includes several signal processing stages. In a first stage, a frequency splitter 406 splits the audio input signal 216 into a set of frequency bands. In the illustrated example, the frequency splitter 406 splits the vibration signal into an upper frequency signal 408 (which includes frequencies above a cutoff frequency) and a lower frequency signal 410 (which includes frequencies below the cutoff frequency). In other embodiments, the frequency splitter 406 may split the signal into three or more frequency ranges. A frequency shifter 412 then shifts at least one the frequency band signals 408, 410, which are then recombined by a combiner 414. For example, in one implementation, the upper frequency signal 408 is shifted to a lower frequency range the combiner 414 recombines the lower frequency signal 410 and the downshifted upper frequency signal. This has the effect of producing an output vibration signal without high frequency vibrations (or with sufficiently attenuated high frequency vibrations) that may produce undesirable audible noise with some types of transducers 166. This approach may also beneficially cause the user to better sense vibrations for transducers that respond more powerfully to lower frequency ranges. In other examples, the frequency shifter 412 may instead shift the lower frequency signal 410 to a higher frequency range. This implementation may be useful for other types of transducers that have higher peak response frequencies and may thus respond more powerfully to frequencies above a certain threshold. In yet further embodiments, a combination of frequency shifts may be applied.

In this example, the vibration signal generation module 210 also includes an adaptive equalizer 416 that applies an equalization to the vibration signal that may be dynamically dependent on the vibration intensity control 306. A specific example of this equalization technique is shown in the graphs 420, 422. Particularly, graph 420 shows an equalization curve characterized by the gain applied to the vibration signal at different frequencies. In this example, the vibration signal is equalized to apply relatively higher gain to mid-range frequencies relative to the gain applied to low-range frequencies. The ratio of the mid-range frequency gain to low-range frequency gain may be dependent on the vibration intensity control 306 as shown in graph 422. Here, the ratio decreases with increasing vibration intensity. In some embodiments, the gain applied to mid-range frequencies may be zero above a certain threshold intensity. Thus, at lower vibration intensity settings, the vibration signal may be more significantly composed of mid-range frequencies, while at high vibration intensity settings, a flatter equalization is applied to allow for less attenuated low range frequencies and/or more attenuated mid-range frequencies. The equalizer 416 may furthermore apply additional filters to reduce noise from the transducer 166 such as an additional low pass filter as described above. Furthermore, as described above, additional dynamic gain adjustments and/or equalization may be applied based on sensed temperature of the stimulation device 160 (e.g., to maintain temperature below a set point). An amplifier 418 may follow the equalizer 416 to apply a gain to the vibration signal dependent on the vibration intensity control 306 as described above.

The equalization technique described above can beneficially reduce or avoid overheating of the transducer 166 that can otherwise occur when gain of the vibration signal is increased. For some types of transducers 166, heating may be most significantly attributed to mid or high range frequencies at increased intensity levels. Using the above technique, when the user increases the gain, the low frequency signals will increase more than the mid-level frequencies. From the user's perspective, the effect of the desired increase in vibration intensity is achieved via these increased low-frequency vibrations. However, the relatively lower increase in mid-range frequencies may avoid or mitigate overheating. Because the user does not sense high frequency vibrations as well as lower frequency vibrations, this benefit can be achieved while still providing the desired user experience.

In alternative embodiments, the vibration signal generation module 210 may include only a subset of signal processing techniques described above and/or different stages of the signal processing may occur in different orders. Moreover, other embodiments may employ different types of equalization curves, which may be static and/or dynamic dependent on the vibration intensity control 306 or other conditions.

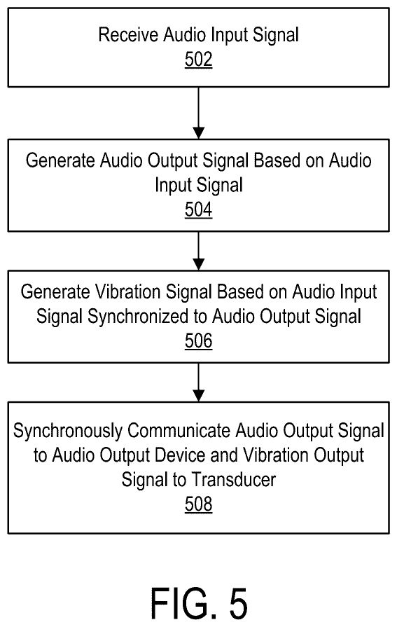

FIG. 5 is a flowchart illustrating an example method for operating an immersive stimulation system 100. The immersive stimulation system 100 receives 502 an audio signal (e.g., at the control device 110). The immersive stimulation system 100 generates 504 an output audio signal based on the input audio signal. The immersive stimulation system 100 may directly pass through the audio input signal to the audio output signal or may apply one or more signal processing transformations to the audio input signal to generate the audio output signal. For example, the immersive stimulation system 100 may apply a gain to the audio input signal based on a gain control signal (e.g., which may be controlled by an audio volume knob or other volume control element). Furthermore, the immersive stimulation system 100 may apply one or more filters (e.g., an equalization filter) one or more audio effects, or other signal processing functions to the audio input signal to generate the audio output signal.

The immersive stimulation system 100 furthermore generates 506 a vibration signal based on the audio signal, which is time-synchronized to the audio signal based on frequency, amplitude, or a combination thereof. For example, as described above, the vibration signal may be generated such that its frequency and/or intensity changes with changing frequency spectrum of the audio signal. The immersive stimulation system 100 synchronously communicates the audio output signal to an audio output device (e.g., speakers) and communicates the vibration signal to a transducer 166 of the stimulation device 160.

FIG. 6 illustrates an example form factor for an immersive stimulation system 100. In this example, the control device 110 has a housing suitable for placement on a tabletop (such as nightstand). The various control elements (e.g., audio volume controller 118, vibration intensity controller 120, on/off switch 114), indicators 116, and ports (e.g., vibration output port 122, audio output port 124) are placed in easily accessible positions on the front face of the housing together with a pair of stereo speakers 112. This example of the immersive stimulation system 100 furthermore includes a stimulation device 160 with a disc-like base unit 162 and a detachable vibratory unit 164 having a dildo-like form factor. FIG. 6 represents just one example of form factors for the control device 110 and stimulation device 160. As described above, the stimulation system 100 may be implemented in a variety of form factors and may include one or more detachable vibratory units 164 to enable versatile use of the stimulation system 100.

FIG. 7 illustrates another example form factor for a vibratory unit 164 that can attach to a base unit 162 of the stimulation device 160. In this example, the vibratory unit 164 comprises a disc-shaped base 702, a central ridge 704, an arm 708, and a bulb end 710. The disc-shaped base 702 may be structured to couple with a complementary disc-shaped base unit 162 that includes the integrated one or more transducers 166. Any suitable coupling mechanism may be employed. In some implementations, a quick release securing mechanism may be employed to enable the vibratory unit 164 to couple and decouple from a corresponding base unit 162 without any tools. In an embodiment, the disc-shaped base 702 may include a securing structure on a bottom surface (not shown) that couples with a reciprocal structure of the base unit 162. The disc-shaped base 702 may have a convex upper surface with a central ridge 704 protruding over a central axis of the disc-shaped base 702. The arm 708 may extend from one edge of the disc-shaped base adjacent to an end of the central ridge 704. The arm 708 may have a curved structure that curves outward from the disc-shaped base 702 and then arcs back towards the disc-shaped base 702. The curved path of the arm 708 may be in a plane substantially perpendicular to a plane of a primary cross-section of the disc-shaped base 702. For example, in the illustrated coordinate system, the primary cross-section of the disc-shaped base 702 lies in the x-z plane, and the central path of the curved arm 708 lies in the x-y plane. The arm 708 includes a bulb end 710 with a wider radius than the main section of the arm 708. The bulb end 710 may be tapered such that it is narrower where it connects to the arm 708 and then widens slightly. This particular design of the vibratory unit 164 may be suitable for sexual stimulation of female anatomy. In this usage, the bulb end 710 may be inserted into the vagina while the central ridge 704 is positioned to concurrently provide stimulation to the clitoris.

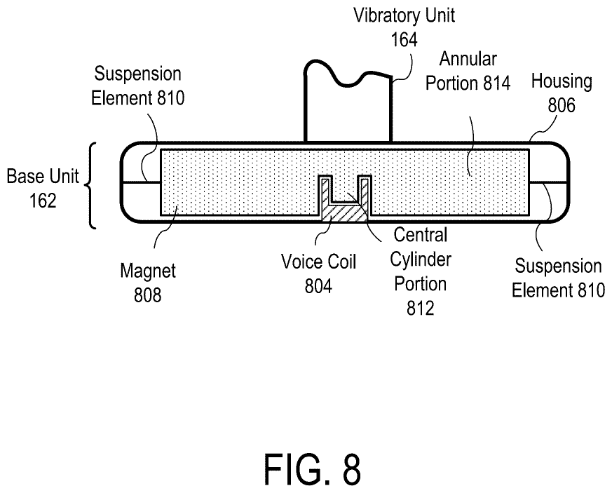

FIG. 8 is a cross-sectional view illustrating an example structure for a base unit 162. In this example, the base unit 162 includes a transducer 166 comprising a voice coil 804 that generates a magnetic field in response to the electrical vibration signal passing through the voice coil 804. The voice coil may comprise a wire that forms loops around a central cylinder. The voice coil 804 may be rigidly affixed to a housing 806 of the base unit 162 (e.g., via an adhesive). The base unit 162 furthermore includes a magnet 808 (or a set of magnets 808) that is non-rigidly coupled to the housing 806 via a suspension element 810 (e.g., rubber or cloth flexible membrane, spider suspension, or other suspension mechanism). In a particular implementation, the magnet 808 comprises an annular portion 814 that is movable along an outer surface of the voice coil 804 and a central cylinder portion 812 that is movable along an inner surface of the voice coil 804. The magnet 808 may generally have a much larger mass than the voice coil 804. This structure enables the magnet 808 to move semi-freely relative to the rigidly attached voice coil 804 (as constrained by the suspension element 810) in response to a motive force of the magnet 808 generated by the magnetic field. The vibratory unit 164 couples to the housing 806 such that the vibratory force is transferred to the vibratory unit 164. In an alternative implementation, the vibratory unit 164 may instead be coupled to the magnet 808 via a cutout through the housing 806.

In an alternative implementation, the magnet 808 may be rigidly affixed to the housing of the base unit 162, and the voice coil 804 may instead be non-rigidly coupled via a suspension element 810, such that the voice coil 804 (instead of the magnet 808) moves relative to the housing 806 of the base unit 162.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A stimulation system comprising:
a control device to receive an audio input signal and to generate an audio output signal applied to one or more speakers, and to generate a vibration signal for outputting externally, wherein the vibration signal comprises a dynamically varying frequency spectrum synchronized to a frequency spectrum of the audio output signal; and
a stimulation device comprising:
a base unit communicatively coupled to the control device to receive the vibration signal and to apply the vibration signal to an integrated transducer that causes vibrations of the base unit; and
a vibratory unit coupled to the base unit such that the vibrations of the base unit is transferred to the vibratory unit.

2. The stimulation system of claim 1, wherein the vibratory unit is detachable from the base unit, wherein the base unit includes a first mating structure, and wherein the vibratory unit comprises a second mating structure reciprocal to the first mating structure.

3. The stimulation system of claim 1, wherein the base unit and the vibratory unit comprise a unibody construction.

4. The stimulation system of claim 1, wherein the control device comprises:
a power supply to supply power to the control device;
an audio input port to receive the audio input signal;
an audio signal generation module to generate the audio output signal from the audio input signal based in part on an audio volume control input;
a vibration signal generation module to generate the vibration signal from the audio input signal based in part on a vibration intensity control input;
an audio output device to output the audio output signal; and
a vibration signal output port to output the vibration signal.

5. The stimulation system of claim 4, wherein the audio output device comprises one or more integrated speakers.

6. The stimulation system of claim 4, wherein the audio output device comprises a wired or wireless audio output interface for communicating the audio output signal to one or more external speakers.

7. The stimulation system of claim 4, wherein the control device further comprises:
one or more frequency filters to filter the audio input signal to generate the vibration signal.

8. The stimulation system of claim 7, wherein the one or more frequency filters comprises a low-pass filter.

9. The stimulation system of claim 4, wherein the control device further comprises:
an equalizer to apply variable gain to different frequency ranges of the audio input signal to generate the vibration signal.

10. The stimulation system of claim 9, wherein the equalizer comprises a dynamic equalizer that applies relatively lower gain to a mid-range of frequencies relative to a low-range of frequencies in response to an increasing vibration intensity control input.

11. The stimulation system of claim 4, wherein the control device further comprises:
a frequency shifter device to shift a frequency range of the audio input signal to a different frequency range to generate the vibration signal.

12. The stimulation system of claim 1, wherein the base unit comprises:
a housing;
a voice coil rigidly coupled to the housing;
a magnet; and
a suspension element coupled to the magnet and flexibly coupled to the housing such that the magnet vibrates relative to the housing in response to a magnetic field generated by the voice coil.

13. The stimulation system of claim 1, wherein the vibratory unit is structured in a form factor of a dildo, plug, sleeve, or ring device.

14. The stimulation system of claim 1, wherein the vibratory unit comprises a mechanical structure without integrated electronics.

15. The stimulation system of claim 1, wherein the vibratory unit comprises:
a disc-shaped base; and
an arm extending from an edge of the disc-shaped base along a curved path in a plane substantially perpendicular to a plane of a primary cross-section of the disc-shaped base; and
a bulb end at the end of the arm, the bulb end having a wider radius than the arm.

16. The stimulation system of claim 1, wherein the base unit further comprises a temperature sensor, and wherein the control device is further configured to dynamically control a gain of the vibration signal in response to the temperature.

17. A stimulation system comprising:
a control device to receive an audio input signal and to generate an audio output signal applied to one or more speakers, and to generate a vibration signal for outputting externally to the control device, wherein the vibration signal comprises a dynamically varying frequency spectrum synchronized to a frequency spectrum of the audio output signal; and
a base unit communicatively coupled to the control device to receive the vibration signal and to apply the vibration signal to an integrated transducer that causes vibrations of the base unit, the base unit including a first mating structure to removably mate with a reciprocal mating structure of a vibratory unit.

18. The stimulation system of claim 17, wherein the control device comprises:
a power supply to supply power to the control device;
an audio input port to receive the audio input signal;
an audio signal generation module to generate the audio output signal from the audio input signal based in part on an audio volume control input;
a vibration signal generation module to generate the vibration signal from the audio input signal based in part on a vibration intensity control input;
an audio output device to output the audio output signal; and
a vibration signal output port to output the vibration signal.

19. A method for operating a stimulation system comprising:
receiving, by a control device, an audio input signal;
generating, by the control device, an audio output signal for driving one or more speakers;
generating, by the control device, a vibration signal for driving one or more transducers external to the control device, wherein the vibration signal comprises a dynamically varying frequency spectrum synchronized to a frequency spectrum of the audio output signal;
communicating the audio output signal to the one or more speakers to cause the one or more speakers to output ambient audio; and
communicating the vibration signal to a base unit to drive an integrated transducer that causes vibration of the base unit in synchronization with the ambient audio.

20. The method of claim 19, wherein generating the vibration signal comprises:
applying a frequency shift to shift frequencies of the audio input signal within a frequency range to a different frequency range.
